(19) United States
(12) Patent Application Publication
(10) Pub. No.: US 2009/0159521 A1
(43) Pub. Date: Jun. 25, 2009

(54) METHOD AND APPARATUS RELATED TO LIQUID FILTRATION SYSTEMS

(76) Inventors: Rudolph Luning, Gottingen (DE); Uwe Klaus, Radeberg (DE); Laurence J. Purcell, Weston (CA)

Correspondence Address: BERESKIN AND PARR, 40 KING STREET WEST, BOX 401, TORONTO, ON, M5H 3Y2, CA

(21) Appl. No.: 12/343,676

(22) Filed: Dec. 24, 2008

Related U.S. Application Data
(63) Continuation of application No. PCT/IB2007/003750, filed on Jul. 5, 2007.
(60) Provisional application No. 60/832,384, filed on Jul. 21, 2006.

(51) Int. Cl. B01D 63/02; B01D 67/00

(52) U.S. Cl. 210/256; 210/321.6; 156/60

(57) ABSTRACT

A filtration module comprises a housing having an inlet and an outlet; a plurality of hollow fiber membranes disposed in the housing, each membrane having a wall and a lumen open to the outlet; a porous shell disposed in the housing and encasing the plurality of hollow fiber membranes, the shell having an opening through which ends of the hollow fiber membranes pass; and a plug in the outlet, the ends of the hollow fiber membranes passing through the plug and the shell ending in the plug. A liquid treatment apparatus comprising the filtration module is also disclosed, as are method for making the filtration module and the liquid treatment apparatus.

This is a continuation of International Application No. PCT/IB2007/003750 filed Jul. 5, 2007, which claims the benefit of U.S. provisional Application No. 60/832,384 filed Jul. 21, 2006. All of the applications listed above are incorporated herein, in their entirety, by this reference to them.

### FIELD OF THE INVENTION

The information disclosed herein relates to apparatuses for treating liquids, such as for example, apparatuses for providing potable water from a supply of non-potable water. Methods for making such apparatuses and elements thereof, and methods for treating liquids are also disclosed.

### BACKGROUND OF THE INVENTION

U.S. Pat. No. 5,895,573 (Scharstuhl) discloses an ultrafiltration device for domestic water supply which removes microorganisms and organic contamination. The device includes a bundle of capillary ultrafiltration membranes fitted in a filter housing, whereby the capillary membranes are open at a first end and closed at another end and are at the first end held in a membrane holder, which closes off the space in between the capillary membranes and the filter housing.

U.S. Pat. No. 5,897,782 (Chatelin) discloses an invention relating to adsorbing antimicrobial agents contained in a biological fluid by passing the fluid over and through a fibrous material that is free of binding agents and is formed of activated carbon fibers.

German Patent No. DE1798208 (Dutz) discloses an invention in which a separation column for liquid chromatography is contstructed by taking a bundle of parallel inorganic chemical fibers produced from glass which serves as a liquid stationary phase and surrounding it by a sleeve of chemically resistant material which is shrunk on said bundles of fibers. After a heat treatment a phase separation takes place and then the soluble phase is eliminated by a leaching and washing procedure so that a porous glass remains.

European Patent No. EP0841086 (Gurudath) discloses a fluid separation module and a process for utilizing the module containing a bundle of hollow fiber membranes and randomly dispersed within the bundle of fibers are filaments having an outer diameter from about 60 to about 3000 microns. The hollow fibers have an outer diameter from about 100 to about 1000 microns. The filaments are present in number from 0.5 to 5 filaments per fiber. The filaments can be placed among the fibers during manufacturing of the fibers and/or bundle. The presence of the filaments is thought to enhance the performance of the fluid separation module.

### SUMMARY OF THE INVENTION

The following summary is intended to introduce the reader to the disclosure provided herein but not to define any invention. In general, this disclosure describes one or more methods or apparatuses for

According to one aspect, a filtration module is disclosed, the filtration module comprising: a housing having an inlet and an outlet; a plurality of hollow fiber membranes disposed in the housing, each membrane having a wall and a lumen open to the outlet; a porous shell disposed in the housing and encasing the plurality of hollow fiber membranes, the shell having an opening through which ends of the hollow fiber membranes pass; and a plug in the outlet, the ends of the hollow fiber membranes passing through the plug and the shell ending in the plug.

The plug can comprise cured potting resin. The hollow fiber membranes can be potted in the outlet. The shell can be potted in the outlet. The hollow fiber membranes can be potted in the opening of the shell. The porous shell can comprise a structurally stable cylindrical tube, the opening comprising an open end of the tube. The porous shell can comprises activated carbon. The housing can comprise two panels. The two housing panels can be configured so that when joined together to in facing relation, a chamber for receiving the membranes and shell is formed.

According to another aspect, a filter module is disclosed, the filter module comprising: a first housing panel having a first recess; a second housing panel having a second recess, the second housing panel joined to the first housing panel to form a housing with the first and second recesses cooperating to form a filter chamber in the housing, the housing having an inlet and an outlet in fluid communication with each other through the chamber; and a filter assembly disposed in the filter chamber. The first and second housing panels can comprise molded plastic. The first and second housing panels can be identical to each other.

According to another aspect a pair of panels for a filter module is disclosed, the pair of panels comprising: a first panel; and a second panel; the panels configured to cooperate to form a filter chamber, a pocket for holding a supply of potting resin, and a channel extending between the chamber and the pocket when the first and second panels are joined together in facing relation. The first and second panels can each comprise respective first and second locating buttons configured to interengage when the first and second panels are joined together in facing relation.

According to another aspect, a module potting apparatus is disclosed, comprising: a housing, the housing having an outlet; a filter assembly in the housing, the filter assembly including hollow fiber membranes having ends in the outlet; a potting carrier joined to the housing, the potting carrier including a pocket for holding uncured resin therein and a channel extending from the pocket to the outlet.

According to another aspect, a method of making a filter module is disclosed, comprising: providing a module potting apparatus having a body, the body including a filter housing and a potting carrier joined to the filter housing, the potting carrier comprising a pocket and a channel extending from the pocket to an end of the filter housing; providing an amount of uncured resin in the pocket; and spinning the module potting apparatus about an axis, wherein the resin flows from the pocket through the channel and into the end of the filter housing.

The resin can be cured after the resin has moved to the end of the filter housing. The potting carrier can be separated from the filter housing after the resin has moved to the end of the filter housing. A filter assembly in can be provided in the housing, the filter assembly comprising hollow fiber membranes having ends disposed adjacent the end of the filter housing. The ends of the hollow fiber membranes can be plugged prior to spinning the module potting apparatus about an axis.

According to another aspect, a method of making a liquid treatment apparatus is disclosed, comprising: placing a filter module between a first and a second plastic sheets, the filter module having a housing with an inlet for receiving liquid to be treated and an outlet for discharging treated liquid; joining the first and second sheets and the housing together along an intermediate seam, the intermediate seam having a central segment along which the first and second sheets are bonded to the housing on opposing first and second sides of the inlet, respectively, and the intermediate seam having on either side of the central segment a distal segment along which the first and second sheets are bonded together; and joining the sheets together along a reservoir defining seam, the reservoir defining seam extending from opposing ends of the intermediate seam and defining a reservoir in communication with the filter module.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present disclosure and are not intended to limit the scope of what is taught in any way. In the drawings:

FIG. 1 is a view of a liquid treatment apparatus according to one aspect of the applicant's teaching;

FIG. 2 is a perspective view of the apparatus of FIG. 1;

FIG. 3 is a cross-sectional view of the apparatus of FIG. 1 taken along the lines 3-3;

FIG. 4 shows the apparatus of FIG. 3, with liquid in first and second reservoirs thereof;

FIG. 5 is a perspective view of a filter module of the apparatus of FIG. 1;

FIG. 6 is a sectional view of the filter module of FIG. 5 taken along the lines 6-6;

FIG. 7 is an enlarged end portion of the filter module of FIG. 5 showing a plug element in greater detail;

FIG. 8 is an enlarged portion of the apparatus of FIG. 4;

FIG. 9 is a perspective view of an apparatus from which the filter module of FIG. 5 can be made;

FIG. 10 is an exploded perspective view of the apparatus of FIG. 9;

FIG. 11 illustrates a spinning step used in a method of making the filter module of FIG. 5 from the apparatus of FIG. 9;

FIG. 12 is a perspective view of the apparatus of FIG. 9 after the spinning step of FIG. 11;

FIG. 13 is an alternate example of a water treatment apparatus in accordance with the applicant's teaching; and

FIG. 14 is a cross sectional view of a portion of the apparatus of FIG. 13 taken along the lines 14-14.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

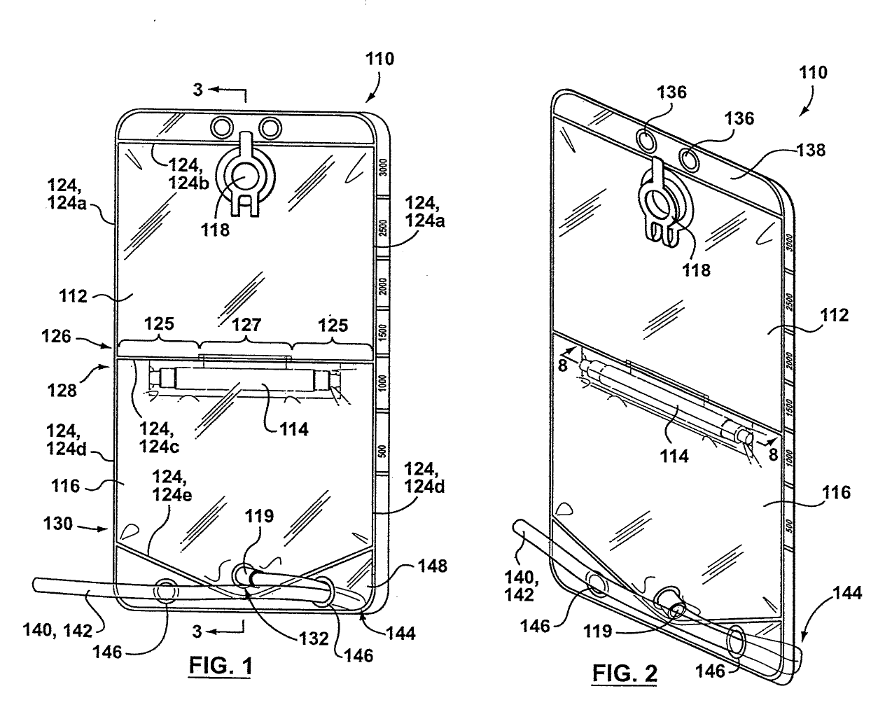

A liquid filtration apparatus 110 in accordance with the applicant's teaching is shown in FIGS. 1 and 2. The apparatus 110 has a first reservoir 112 (also referred to as “upper reservoir”), a filter module 114 for receiving liquid from the first reservoir 112, and a second reservoir 116 (also referred to as “lower reservoir”) for receiving liquid from the filter module 114. The apparatus 110 has a fill port 118 for filling the first reservoir 112 with untreated liquid, and a dispensing outlet 119 for dispensing treated liquid from the second reservoir 116.

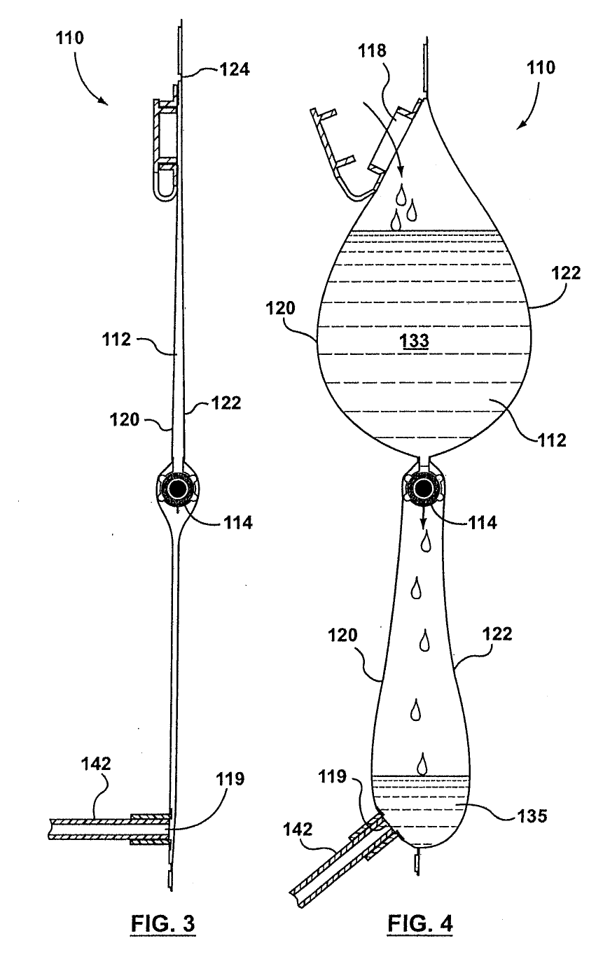

Referring now also to FIG. 3, the apparatus 110 comprises a front sheet 120 and a back sheet 122 overlying the front sheet 120. The front and back sheets 120, 122 are liquid impermeable, and are joined to each other along seams 124 to form the first and second reservoirs 112, 116. The first reservoir 112 has generally vertical side seams 124a, an upper transverse seam 124b extending between the side seams 124a and a lower end 126 defined by an intermediate seam 124c extending transversely between the side seams 124a, and spaced apart from the upper seam 124b. The intermediate seam 124c, in the example illustrated, joins the front and rear sheets directly together along a pair of distal segments 125 extending inwardly from the respective opposing side seams 124a. Between the distal segments 125, a central segment 127 of the intermediate seam 124c joins the front and back sheets 120, 122 to respective front and rear sides of the filter module 114, around a filter inlet 154 provided therein.

The seams 124 are, in the example illustrated, formed of thermal welds that bond the sheets 120, 122 together or to an adjacent surface such as that provided by the filter module along the central segment 127 of the intermediate seam 124c. Other seam structures, such as, for example, but without limitation, adhesives, ultrasonic bonds, or stitching could also be used, separately or in combination, to form the seams 124.

The second reservoir 116 has side seams 124d extending generally as continuations of the side seams 124a of the first reservoir 112. The intermediate seam 124c defines an upper end 128 of the second reservoir 116. The second reservoir 116 has a lower end 130 defined by a lower seam 124e extending transversely between the side seams 124d. The lower seam 124e can be inclined from the horizontal to define a lowermost point 132 of the second reservoir 116 to which water can be directed for evacuation through the outlet 119.

In use, and referring now to FIG. 4, the first (upper) reservoir 112 can be filed with an untreated liquid 133 such as, for example, but not limited to, raw water, which can be obtained from a raw water supply such as a lake or stream. When the first reservoir 112 has been filled to a desired amount, the apparatus 110 can be suspended in a vertical position, for example, by hanging the apparatus 110 from optional suspension apertures 136 through which a hook or hanger can pass. In the example illustrated, a pair of suspension apertures 136 are provided in an upper flap 138 that extends from the upper seam 124b, opposite the first reservoir 112 (FIG. 2). Suspending the apparatus 110 in a vertical position can allow gravity to draw the untreated liquid 133 from the first reservoir 112 into the inlet 154 of the filter module 114. The untreated liquid 133 passes through the filter module 114, producing treated liquid 135 that is discharged through a filter outlet 156 and into the second (lower) reservoir 116. The treated liquid 135 (e.g. potable water) can be dispensed for use from the second reservoir 116 via the dispensing outlet 119.

Referring again to FIGS. 1 and 2, to facilitate dispensing the treated liquid 135 in the second reservoir 116 when needed, the outlet 119 can be provided with a valve member 140. The valve member 140 can be moved between a shut-off position and a flow position for alternately blocking and allowing flow from the second reservoir 116 through the outlet. In the example illustrated, the valve member 140 comprises a length of flexible tubing 142 that can be folded and unfolded to correspond to the shut-off and flow positions, respectively. When in the folded condition, the tubing 142 is pinched closed at the fold 144 so that liquid flow through the tube 142 is prevented. One or more retaining apertures 146 can be provided in a lower flap portion 148 of the apparatus 110 (below the second reservoir 116) to releasably retain the tubing 142 in the folded state.

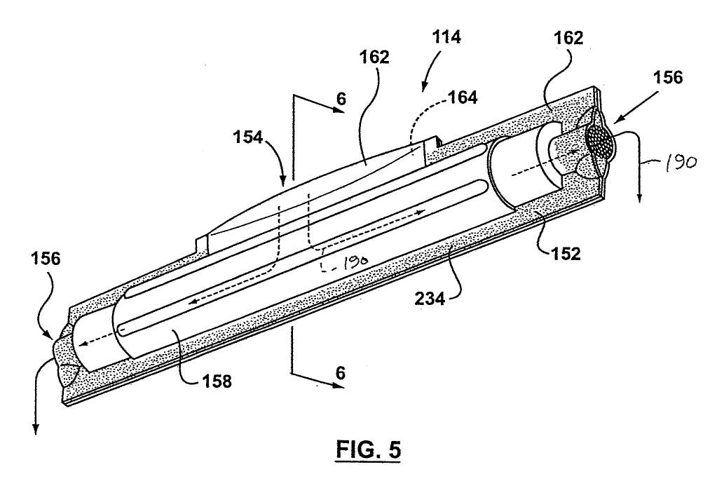

Referring now to FIG. 5, further details of the filter module 114 will be described. The filter module 114 comprises a housing 152 having at least one inlet 154 and at least one outlet 156. In the example illustrated, the housing 152 defines a filter chamber 158 that is generally cylindrical in shape, and that has one outlet 156 located at each end. The inlet 154 is located along a sidewall portion of the housing 152, intermediate the opposed outlets 156, and is oriented to face upwards in the apparatus 110 to facilitate receiving liquid into the inlet 154 from the first reservoir 112.

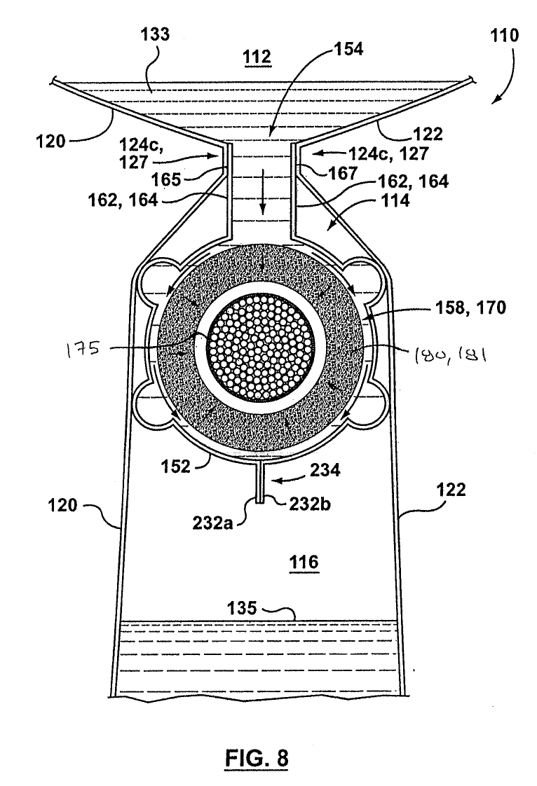

The housing 152 can have an upper fin 162 extending radially outwardly from the filter chamber 158 and along the length thereof. In the example illustrated, the fin 162 is sandwiched between the front and back sheets 120, 122 along the intermediate seam 124c of the apparatus 110. As seen also in FIG. 8, the fin 162 can have a front wall 164 and back wall 166 that are spaced apart from each other at an intermediate location along the length of the housing 152 between the opposing ends (i.e. along the central segment 127 of the intermediate seam 124c) to define the filter inlet 154, the inlet 154 extending between the walls 164, 166 and opening to the chamber 158.

In the example illustrated, the front and back walls 164, 166 of the fin 162 provide respective front and back surfaces 165, 167 to which the front and back sheets 120, 122 are respectively bonded along the central segment 127 of the intermediate seam 124c. The untreated liquid 133 in the first reservoir 112 is prevented from directly flowing into the second reservoir 116 by the distal segments 125 of the intermediate seam 124c, and can enter the second reservoir 116 only by passing through the filter module 114 via the filter inlet 154 and outlet 156.

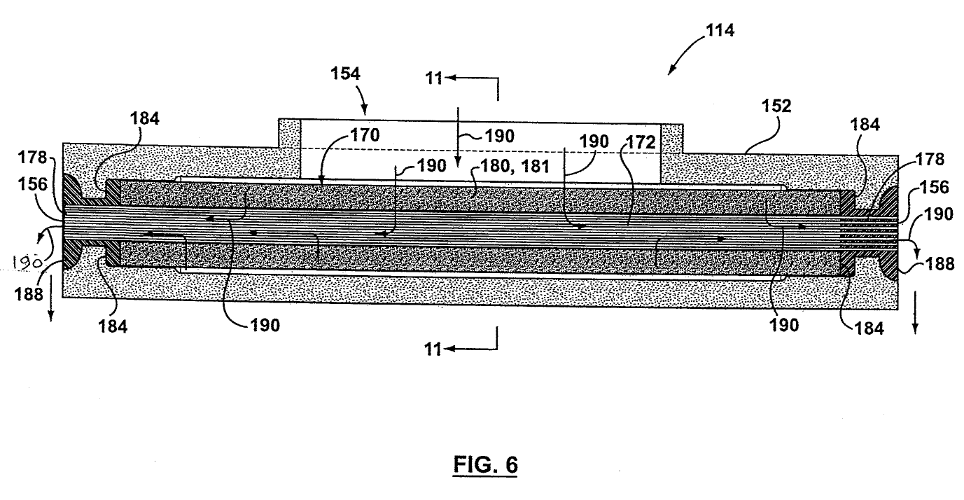

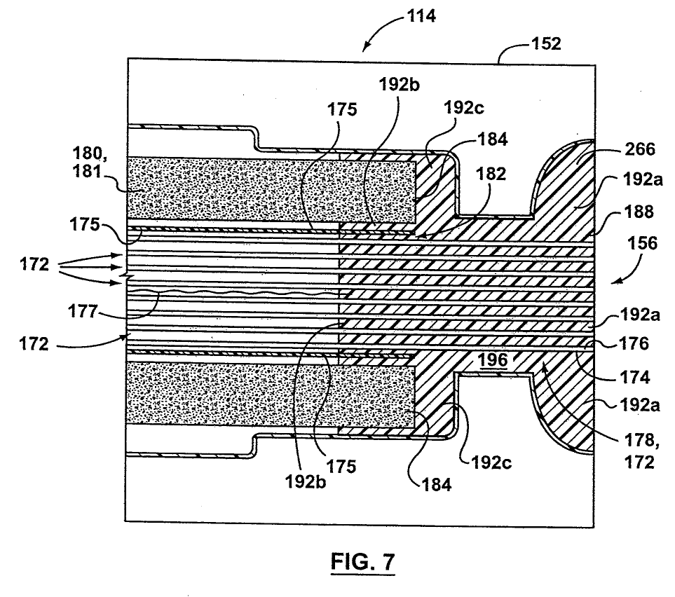

As seen in FIGS. 6, 7, and 8, within the housing 152 of the filter module 114 is provided a filter assembly 170. The filter assembly 170 comprises a plurality of hollow fiber membranes 172 each having a wall 174 and a lumen 176 (FIG. 7). The hollow fiber membranes 172 can be grouped together to form a bundle having a generally cylindrical configuration. The walls 174 of the membranes 172 are liquid permeable and can of a polymer, such as PVDF, polyester, polysulfane, or polypropylene made porous by, for example, thermal or non-thermal induced phase separation or stretching. In the example illustrated, the hollow fiber membranes 172 extend between the opposed outlets 156, with the lumens 176 open to the outlets 156 at respective ends 178 of the membranes 172. The hollow fiber membranes 172 have pores in the microfiltration range or smaller, and so can filter or separate impurities of very small size, including, for example, viruses or bacteria that may be present in the untreated liquid 133.

The filter assembly 170 further comprises a porous shell 180 that generally encases the plurality of hollow fiber membranes 172. The porous shell 180 can be in the form of a screening member for blocking passage of relatively large impurities that may be present in the untreated liquid. The porous shell 180 can protect the hollow fiber membranes 172 from damage or fouling by blocking passage of relatively large particulate thereto. The porous shell 180 can also or alternatively be of a material that removes contaminants such as chlorine from the untreated liquid. In the example illustrated, the porous shell 180 comprises activated carbon formed into a structurally stable tube 181 that is generally cylindrical in shape, and sized to fit in the central chamber 158 of the housing 152.

The filter assembly 170 can include a sheath 175 that is generally cylindrical in shape and that wraps around the plurality of hollow fiber membranes 172. The sheath 175 can comprise a porous fabric that can act as an additional filtering element. In the example illustrated, the sheath 175 has a longitudinal length equal to the longitudinal length of the tube 181. The sheath 175 can help to protect the hollow fibers membranes 172 from damage during use or assembly of the filter module 114.

The filter assembly 170 can include additional treatment elements, such as, for example, silver material to enhance the operation of the filter module 114. In the example illustrated, the filter assembly 170 includes at least one silver thread 177 bundled within the plurality of hollow fiber membranes. The silver thread 177 can help to reduce bacteria growth in the filter assembly 170, particularly during periods of time between use, when no liquid flows through the filter assembly 170.

The shell 180 has an opening 182 through which respective ends 178 of the membranes 172 pass, to evacuate liquid from within the porous shell 180 to the outlet 156 of the housing 152, via the lumens 176. In the example illustrated, the shell 180 has an opening 182 at each end of the activated carbon tube 181, each opening 182 directed towards a respective outlet 156 of the housing 152. An end portion of the shell 180 encircling each opening 182 defines an opening periphery 184.

The filter module 114 is provided with a plug 188, alternately called a potting head or tubesheet, in each outlet 156. The plugs 188 can facilitate directing liquid from the opening 182 to the outlets 156 along the desired flow path. The ends 178 of the hollow fiber membranes 172 pass through the plug 188. The opening periphery 184 of the porous shell 180 is sealed against and, in the example illustrated, ends within the plug 188.

In the example illustrated, each plug 188 provides at least three sealing functions. First, the plug 188 seals the outlet 156 of the housing 152 so that liquid cannot flow through the outlet 156, other than through the lumens 176 of the hollow fiber membranes 172. Second, the plug 188 seals the opening 182 of the shell 180 so that liquid cannot flow through the opening 182, other than through the lumens 176 of the hollow fiber membranes 172. Third, the plug 188 seals the opening periphery 184 to the inner surface of the housing 152 at the outlet 156, so that liquid cannot flow from the inlet 154 to the outlet 156, other than through the porous shell 180.

To provide the three sealing functions, each plug 188 is, in the example illustrated, provided with three corresponding plug portions 192a, 192b, and 192c. The first plug portion 192a fills the space between the outer surfaces of the walls 174 of the hollow fiber membranes 172 and the inner surface of housing 152 at the outlet 156, and the space between the walls 174 of adjacent hollow fiber membranes 172 at the outlet 156. The second plug portion 192b fills the space between the outer surfaces of the walls 174 of the hollow fiber membranes 172 and the inner surface of the porous shell 180 at the opening 182, and between the walls 174 of adjacent hollow fiber membranes 172 at the opening 182. The third plug portion 192c surrounds the opening 182, and extends from the opening periphery 184 to the inner surface of the housing 152 adjacent the outlet 156. Liquid entering the inlet 154 of the filter module 114 is directed to flow along a flow path 190 (FIG. 6) passing first through the porous shell 180, then through the walls 174 of the hollow fiber membranes 172, and then to the outlet 156 via the lumens 176 of the hollow fiber membranes 172.

The plug 188 can comprise two or more separate elements each corresponding to one or more of the plug portions 192. Alternatively, the plug 188 can be of integral, unitary construction. In the example illustrated, each plug 188 comprises a block of resin 194 formed by flowing resin in an uncured state in each outlet 156 of the housing 152, and then curing the resin. In the example illustrated, the housing 152 at the outlet 156, the end (i.e. opening periphery 184) of the shell 180, and the bundle of hollow fiber membranes 172 cooperate to form a mold cavity 196 for receiving the resin 194. The bundle of hollow fiber membranes 172 has an outer perimetrical extent (in cross-section) that is smaller than the perimetrical extent of the inner surface of the outlet 156 and of the inner surface of the shell 180, providing lateral (or radial) space therebetween for the mold cavity 196. The mold cavity 196 extends longitudinally from an outer edge of the housing 152 at the outlet 156 to a position longitudinally inward of the opening periphery 184 of the shell 180. The longitudinal (or axial) length of the shell 180 is less than the longitudinal length of the filter chamber 158 of the housing 152, providing an axial (longitudinal) space between the end face of the porous shell 180 and the adjacent end face of the chamber 158, which contributes to the volume of the mold cavity 196. The space between the walls 174 of adjacent hollow fiber membranes 172 at the ends 178 thereof further contributes to the volume of the mold cavity 196.

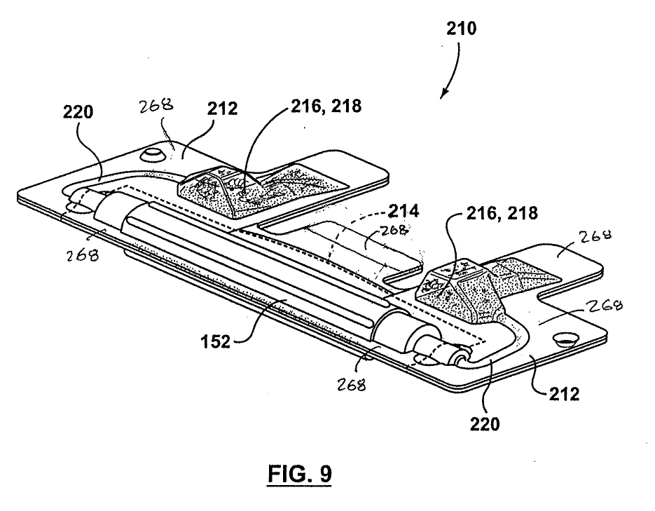

Referring now to FIG. 9, a module potting apparatus 210 can be provided to facilitate potting one or more elements in a body. In the example illustrated, the module potting apparatus 210 is adapted to facilitate potting the hollow fiber membranes 172 in the outlet 158 of the housing 152 and/or in the opening 182 of the shell 180, and/or for potting the opening periphery 184 of the shell 180 in the outlet 156 of the housing 152.

The module potting apparatus 210 in the example illustrated comprises the housing 152 and a potting carrier 212 attached to the housing 152. The potting carrier 212 can comprise an extension of the housing 152 integral with the housing 152 and adapted to be separated from the module 114 prior to use of the module 114. In the example illustrated, the module potting apparatus 210 includes a pair of potting carriers 212, one adjacent each end of the filter chamber 158. The potting carriers 212 are adapted to be severed from the housing 152 by cutting, for example, along the cut line 214 (shown as dashed line in FIG. 9), which corresponds to the outline of the housing 152 of the filter module 114.

Each potting carrier 212 comprises a pocket 216 for holding an amount of uncured potting resin 218. Each potting carrier 212 further comprises at least one channel 220 for delivering the uncured potting resin 218 from the pocket 216 to a target potting zone in the body (i.e. to the mold cavity 196).

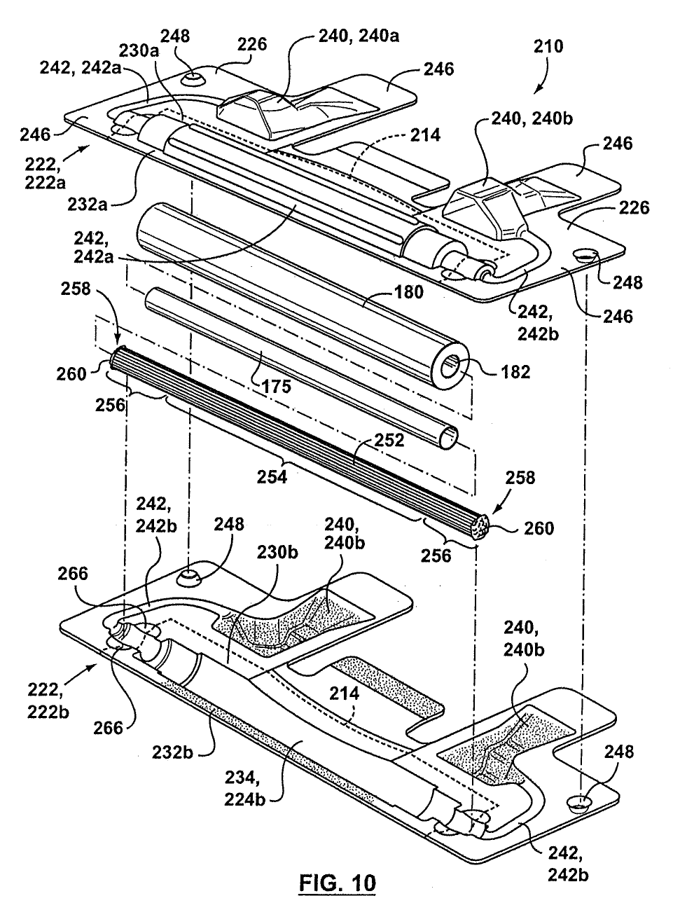

Referring to FIG. 10, the module potting apparatus 210 can comprise a pair of module potting panels 222 (including a front potting panel 222a and a back potting panel 222b) that fit together in facing relation. Each module potting panel 222 can comprise a respective filter housing panel 224 and a carrier panel 226 extending from the housing panel 224. The front and back housing panels 224a, 224b are adapted to overlie and be joined to each other to form the housing 152 (see also FIG. 5). The front and back carrier panels 226a, 226b are adapted to overlie and be joined to each other to form the potting carrier 224.

The front and back housing panels 224a, 224b can have respective front and back filter chamber recesses 228a, 228b therein that cooperate to form the filter chamber 158 in the assembled housing 152. The housing panels 224a, 224b can have respective front and back upper flanges 230a, 230b extending upwardly from an upper edge of the respective chamber recesses 228a, 228b. In the example illustrated, the upper flanges 230a, 230b cooperate to form the upper fin 162 with the spaced-apart front and back walls 164 and 166 forming the filter inlet 154 (FIG. 5).

The housing panels 224a, 224b can have front and back lower flanges 232a, 232b extending from the panels 224 opposite the upper flanges 230 for forming a lower fin 234 (FIG. 5, FIG. 8). The upper and lower fins 162, 234 can facilitate joining together the housing panels 224a, 224b, for example, by providing a surface on which an adhesive can be provided. Adhesive can be provided between the front and back upper flanges 230a, 230b and between the front and back lower flanges 232a, 232b such that the housing 152 is sealed against liquid leakage into or out of the housing 152, other than through the inlet 154 and outlets 156. Alternative or additional methods of bonding together the upper flanges 230a, 230b and the lower flanges 232a, 232b can also be used, such as, for example, thermal or ultrasonic bonding.

The carrier panels 226 of the module potting panels 222 have pocket recesses 240 and channel recesses 242 for forming the pockets 216 and channels 220, respectively, of each potting carrier 212. In the example illustrated, the pocket recesses 240 include a front and back pocket recess 240a, 240b, and the channel recesses 242 include a front and back channel recess 242a, 242b, provided in the front and back carrier panels 222a, 222b, respectively. The channel recesses 242 extend between the pocket recesses 240 of the respective carrier panels 226 and the chamber recesses 228 of the respective housing panels 224.

The carrier panels 226 can have respective carrier panel flanges 246 extending laterally outwardly from the recesses 240, 242. The carrier panel flanges 246 (including front flanges 246a and back flanges 246b) can facilitate joining together the front and back carrier panels 226a, 226b. In the example illustrated, the module potting panels 222 are of an injected molded plastic material and are of identical construction so that a given module potting panel 222 can be used interchangeably as a front potting panel 222a or back potting panel 222b. The module potting panels 222 can be provided with interengaging locating buttons 248 to facilitate aligning the front and back panels 222a, 222b when joining them together to form the module potting apparatus 210. In the example illustrated, one locating buttons 248 is provided in each carrier panel flange 246.

To assemble the module potting apparatus 210, a plurality of extra-length hollow fiber membranes 252 can be arranged in a bundle and can be wrapped within the sheath 175. The extra-length hollow fiber membranes 252 have a longitudinally central portion 254 that corresponds to the hollow fiber membranes 172, and have a membrane extension 256 that extends from each end of the longitudinally central portion 254 and terminates at a free end 258. The free ends 258 of the membrane extensions 256 can be plugged with a bead of sealant 260 to prevent resin 218 from entering the lumens 176 of the fiber membranes 172 during potting.

The extra-length hollow fiber membranes 252 and sheath 175 can be inserted into the interior of the shell 180, and the shell 180 can be placed in the chamber recess 228 of one of the module potting panels (e.g. the back chamber recess 228b of the back 222b potting panel in the example illustrated).

Each channel recess 242 has an inner end 262 that adjoins a respective outer end 264 of each chamber recess 228. The inner end 262 of the channel recesses 242 in the carrier panel 226 and the outer end 264 of the chamber recess 228 in the housing panel 224 can be enlarged in one or more radial (lateral) directions to provide a bulge 266 in the body of the assembled potting apparatus 210, near each outlet 156 of the housing 152. In the example illustrated, the bulge 266 accommodates the membrane extensions 256 of the extra-length membranes 252 and the bead of sealant 260 provided at the ends 258 thereof. The bulge 266 can also help to facilitate the flow of uncured resin 218 from the channel 220 and into the mold cavity 196 during potting.

An amount of uncured potting resin 218 can be provided in each pocket recess. The front module potting panel 222a can then be joined to the back module potting panel 222b, using an adhesive to bond and seal the potting panels 222a, 222b together along designated bond sites 268 thereof. The locating buttons 248 in the front potting panel 222a can be engaged with the locating buttons 248 of the back potting panel 222b to facilitate aligning the potting panels 222a, 222b with respect to each other to form the module potting apparatus 210.

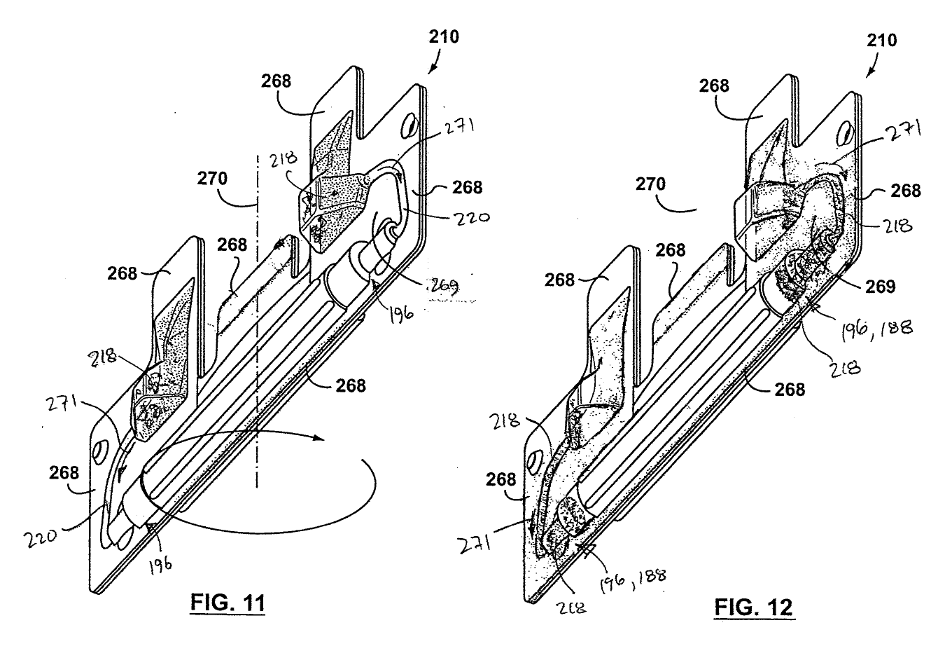

As best seen in FIG. 11, the module potting apparatus 210 is adapted to be rotated about an axis 270 to urge the uncured potting resin 218 from the pockets 216 and into the mold cavity 196. In the example illustrated, the pocket 216 in each potting carrier 212 is positioned inboard of the respective outer end 264 of the filter chamber 158 (relative to the axis 270), and the channel extends between the pocket 216 and the end 264 of the filter chamber 158 in a C-shaped configuration. The pocket 216 is nearer to the rotation axis 270 than is the corresponding mould cavity 196, so that upon spinning the module potting apparatus 210 about the axis 270, the uncured resin 218 will flow (along resin flow path 217) from the pocket 216 to the mould cavity 196 via the channels 220, and thereby pot the hollow fiber membranes and the end of the shell in the outlet of the housing, as well as potting the membranes in the outlet of the shell. Once cured, this potting procedure forms the plugs in the filter module (FIG. 12). The module potting apparatus 210 is spun until the resin cures enough to no longer flow. Alternately, each end of the potting apparatus 210 may be pointed downward in turn for static potting.

After the potting step has been completed, the potting carriers 212 can be detached from the module potting apparatus 210. In the example illustrated, the carriers 212 can be severed from the potting apparatus 210 by cutting the potting panels 222 along the cut line 214. The cutting can include cutting with a sharp blade or other instrument, punching, laser cutting, or other suitable severing methods. When severed along the cut line 214, the membrane extensions 256 and plugged ends 258 of the extra-length fibers 252 are cut off from the central portions 254, leaving the hollow fiber membranes 172 in the housing 152 with open lumens 176 at the outlets 156.

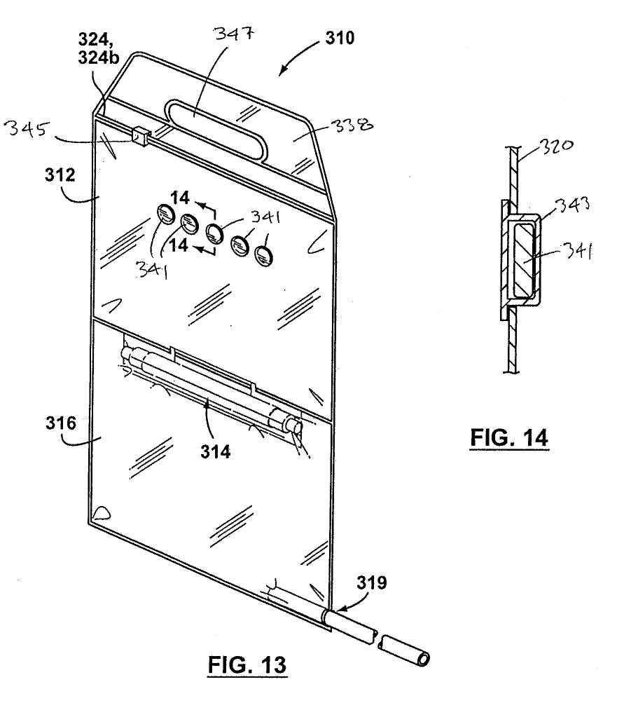

Referring now to FIGS. 13 and 14, another example of a liquid treatment apparatus 310 is shown. The liquid treatment apparatus 310 is similar to the apparatus 110, and like features are identified by like reference characters, incremented by 200. The liquid treatment apparatus 310 includes treatment tablets 341 that can be housed in a rupturable casing 343 for depositing the tablets 331 in the first reservoir 312. In the example illustrated, the rupturable casings 343 are joined to an inner surface of the front sheet 320. The casing 343 can be made of a thin foil layer. By pressing against the tablet 341 through the sheet 320, the casing 343 can be torn, releasing the tablet 341 into the first reservoir 312 for contact with the untreated liquid 333 contained therein. The tablet can comprise one or more germicides for disinfecting the untreated liquid 333, generally prior to allowing the untreated liquid 333 to flow into the inlet 354 of the filter module 314.

Rather than having a fill port, the apparatus 310 can be provided with a releasable-resealable upper seam 324b at an upper end of the first reservoir 312. A slide-lock member 345 can be provided for engaging and disengaging the seam 324b. The apparatus 314 can also be provided with a handle 347 in the upper flap 338, to receive a persons hand for carrying the apparatus 310.

While the above description provides examples of one or more processes or apparatuses, it will be appreciated that other processes or apparatuses may be within the scope of the accompanying claims.

1. A filtration module comprising:
a) a housing having an inlet and an outlet;
b) a plurality of hollow fiber membranes disposed in the housing, each membrane having a wall and a lumen open to the outlet;
c) a porous shell disposed in the housing and encasing the plurality of hollow fiber membranes, the shell having an opening through which ends of the hollow fiber membranes pass; and
d) a plug in the outlet, the ends of the hollow fiber membranes passing through the plug and the shell ending in the plug.

2. The module of claim 1, wherein the plug comprises cured potting resin.

3. The module of claim 2, wherein the hollow fiber membranes are potted in the outlet.

4. The module of claim 2, wherein the shell is potted in the outlet of the housing.

5. The module of claim 2, wherein the hollow fiber membranes are potted in the opening of the shell.

6. The module of claim 1, wherein the porous shell comprises a structurally stable cylindrical tube, the opening comprising an open end of the tube.

7. The module of claim 6, wherein the porous shell comprises activated carbon.

8. The module of claim 1, wherein the housing comprises two panels.

9. A method of making a liquid treatment apparatus comprising:
a) placing a filter module between a first and a second plastic sheets, the filter module having a housing with an inlet for receiving liquid to be treated and an outlet for discharging treated liquid;
b) joining the first and second sheets and the housing together along an intermediate seam, the intermediate seam having a central segment along which the first and second sheets are bonded to the housing on opposing first and second sides of the inlet, respectively, and the intermediate seam having on either side of the central segment a distal segment along which the first and second sheets are bonded together;
c) joining the sheets together along a reservoir defining seam, the reservoir defining seam extending from opposing ends of the intermediate seam and defining a reservoir in communication with the filter module.

10. The method of claim 9, further comprising the step of joining the first and second sheets together along another reservoir defining seam extending from opposing ends of the intermediate seam and defining another reservoir generally opposite the reservoir and in communication with the filter module.

11. A method of making a filter module, comprising:
a) providing a module potting apparatus having a body, the body including a filter housing and a potting carrier joined to the filter housing, the potting carrier comprising a pocket and a channel extending from the pocket to an end of the filter housing;
b) providing an amount of uncured resin in the pocket; and
c) spinning the module potting apparatus about an axis, wherein the resin flows from the pocket through the channel and into the end of the filter housing.

12. The method of claim 11 further comprising the step of curing the resin after the resin has moved to the end of the filter housing.

13. The method of claim 12 further comprising the step of separating the potting carrier from the filter housing.

14. The method of claim 11 further comprising the step of providing a filter assembly in the housing, the filter assembly comprising hollow fiber membranes having ends passing through the end of the filter housing.

15. The method of claim 14 further comprising the step of plugging the ends of hollow fiber membranes prior to step (c).

16. The method of claim 11 wherein the body of the module potting apparatus comprises:
i) a first panel; and
ii) a second panel;
the panels configured to cooperate to form the filter housing, the pocket and the channel extending between the housing and the pocket when the first and second panels are joined together in facing relation.

17. The method of claim 16, wherein the first and second panels each comprise respective first and second locating buttons configured to interengage when the first and second panels are joined together in facing relation.

18. The method of claim 17, wherein the first panel and the second panel are identical.

19. The module of claim 18 wherein the first and second panels comprise molded plastic.
